(19) United States
(12) Patent Application Publication
(10) Pub. No.: US 2023/0306408 A1
(43) Pub. Date: Sep. 28, 2023

(54) SCRIBBLE TEXT PAYMENT TECHNOLOGY

(71) Applicant: Bank of America Corporation, Charlotte, NC (US)

(72) Inventor: Saurabh Gupta, New Delhi (IN)

(21) Appl. No.: 17/700,632

(22) Filed: Mar. 22, 2022

(51) Int. Cl. G06Q 20/32; G06Q 20/10; G06F 3/0354

(52) U.S. Cl. CPC G06Q 20/3278; G06Q 20/105; G06F 3/03545

(57) ABSTRACT

A stylus for use in communicating with a payment instrument is provided. The payment instrument may include a front façade, a sensor touch display, an input and PIN receiver, a financial institution integration component, a payment gateway integration component, a near field communication (NFC) controller, and an authentication module. The stylus may include an input receive and decode component for receiving input related to authentication of a stylus user and for receiving input related to a transaction with the payment instrument. The stylus may also include an integration component for supporting communication with a remote entity and authorizing transactions occurring at the remote entity. The method may include a stylus NFC controller for wirelessly communicating, using NFC protocol, with the payment instrument via the NFC controller associated with payment instrument. In addition, the stylus may include a network interface card component for communicating wirelessly with the remote entity.

### FIELD OF TECHNOLOGY

Aspects of the disclosure relate to communications protocols.

### BACKGROUND OF THE DISCLOSURE

The disclosure relates to mechanisms, and communications protocols for using same, in payment technology.

One industry related to smart technology—i.e., technology that relates to Self-Monitoring Analysis and Reporting Technology—which is currently being underutilized and, if leveraged properly, can provide technological advantages is the device commonly referred to as a “smart pencil.” Such a smart pencil typically refers to an electronically-communicating stylus-like device (referred to hereinafter, in the alternative, as a “stylus”).

Such a stylus, which usually accompanies a user, is a very compact device and typically can be leveraged for various operations.

It would be desirable to provide a specially-developed stylus for implanting user-friendly transactions to another payment card independent of the involvement of any desktop/mobile/laptop device.

It would be further desirable to use such a stylus for further developing digital communications.

It would be yet further desirable to provide a stylus for cards other than special-purpose cards because, typically, a stylus can just be used by the card owner for writing various things on their own card only.

It would be yet further desirable to enable a technology that permits a stylus user to bridge a communications protocol boundary in order to electronically communicate with a card of a different user—e.g., a smart card user's card.

### SUMMARY OF THE DISCLOSURE

A combination stylus and payment instrument is provided. The payment instrument may include a front façade, a sensor touch display, an input and PIN receiver, a financial institution (FI) integration component, a payment gateway integration component, a near field communication (NFC) controller and/or an authentication module.

The stylus may include an input receive and decode component for receiving input related to authentication of a stylus user and for receiving input related to authenticating and/or receiving details of a transaction. The transaction may be performed using the payment instrument.

The stylus may also include an integration component for supporting communication with a remote entity and authorizing transactions occurring, at least in part, the remote entity. And the stylus may include a stylus NFC controller for wirelessly communicating, using a device-agnostic NFC protocol, with the payment instrument via the NFC controller associated with payment instrument. In addition, the stylus may include a network interface card (NIC) component for communicating wirelessly with the remote entity.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram of system that may be configured in accordance with the principles of the disclosure;

FIG. 2 shows illustrative apparatus that may be configured in accordance with the principles of the disclosure;

FIG. 3 shows another illustrative apparatus in accordance with the principles of the disclosure;

FIG. 4 shows yet another illustrative apparatus in accordance with the principles of the disclosure;

FIG. 5 shows yet another illustrative apparatus in accordance with the principles of the disclosure; and

FIG. 6 shows still another illustrative apparatus in accordance with the principles of the disclosure.

### DETAILED DESCRIPTION OF THE DISCLOSURE

A method for using a combination stylus and payment instrument is provided. The stylus may include an input receive and decode component for receiving input related to authentication of a stylus user and for receiving input related to authenticating a transaction. The transaction may be performed, at least in part, using the payment instrument. The stylus may also include a stylus near field communication (NFC) controller for wirelessly communicating, using a device-agnostic NFC protocol, with the payment instrument via an NFC controller associated with the payment instrument. The payment instrument may further include a front façade, a sensor touch display, an input and PIN receiver, a financial institution (FI) integration component, a payment gateway integration component, a network interface card (NIC) component for communicating wirelessly with a remote entity, and/or an authentication module

The method may include receiving the information for the transaction at the payment instrument. The receiving may include receiving touch signals on the sensor touch display or receiving wireless signals from the stylus associated with stylus movements. In some embodiments, the touch signals may be administered by the stylus to the front façade.

The method may also include using the NFC controller associated with the payment instrument to confirm to the stylus the receiving the information for the transaction. Thereafter, the method may include using the NIC component to transmit to the remote entity the information for the transaction. The method may also include using the NIC component to receive from the remote entity confirmation of the transaction.

In some embodiments the method may include receiving and reviewing, using the machine-learning based user data assist component, the transmission to, and confirmation from, the remote entity. Based upon the receipt and the review of transmission to, and confirmation from, the remote entity, the method may invoke one or more of a plurality of actions vis-à-vis the transaction in response to a pre-determined protocol.

In some embodiments, the method may include authenticating, using the authentication component, to the stylus the input related to the transaction. The authentication component may work in tandem with the input receive and decode component—i.e., the authentication component may use the information received from the input receive and decode component to form a finding regarding the authentication of the transaction.

The method may also include electronically confirming, using the NFC controller of the stylus, at least one term of the transaction as marked by the stylus on the sensor touch display of the payment instrument.

The method may be further configured to record, using the input receive and decode component, movements of the stylus in the air and to transmit, using the NFC controller to initiate transmission of wireless signals, said movements from the stylus to the payment instrument.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

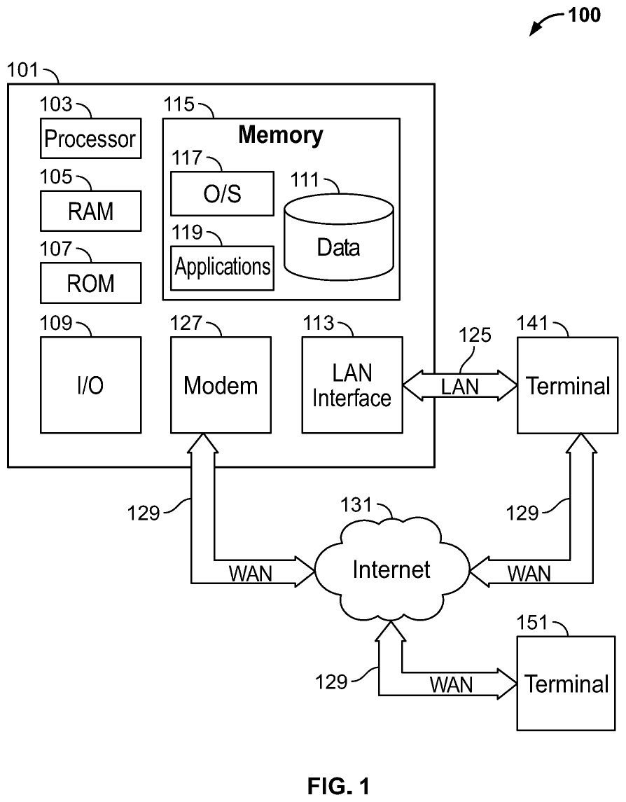

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology— e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of communications received from the stylus and/or the payment instrument as detailed herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

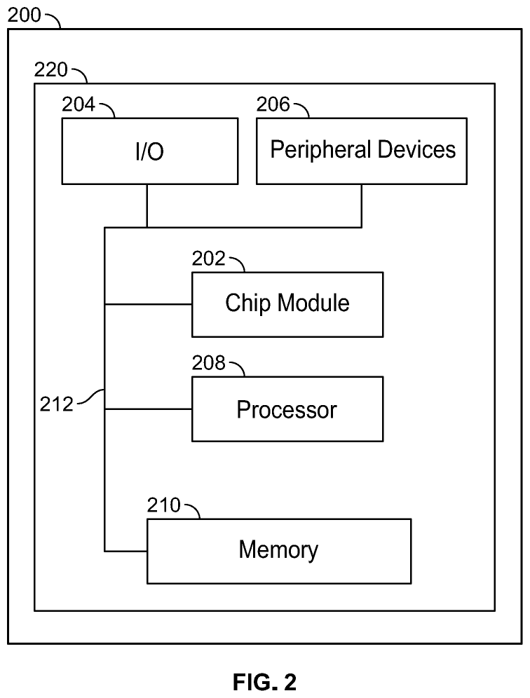

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

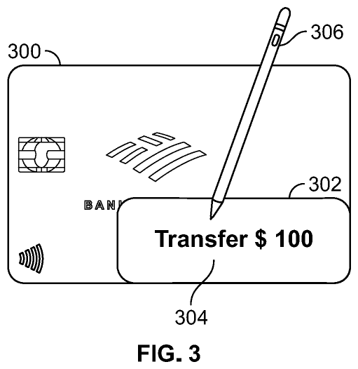

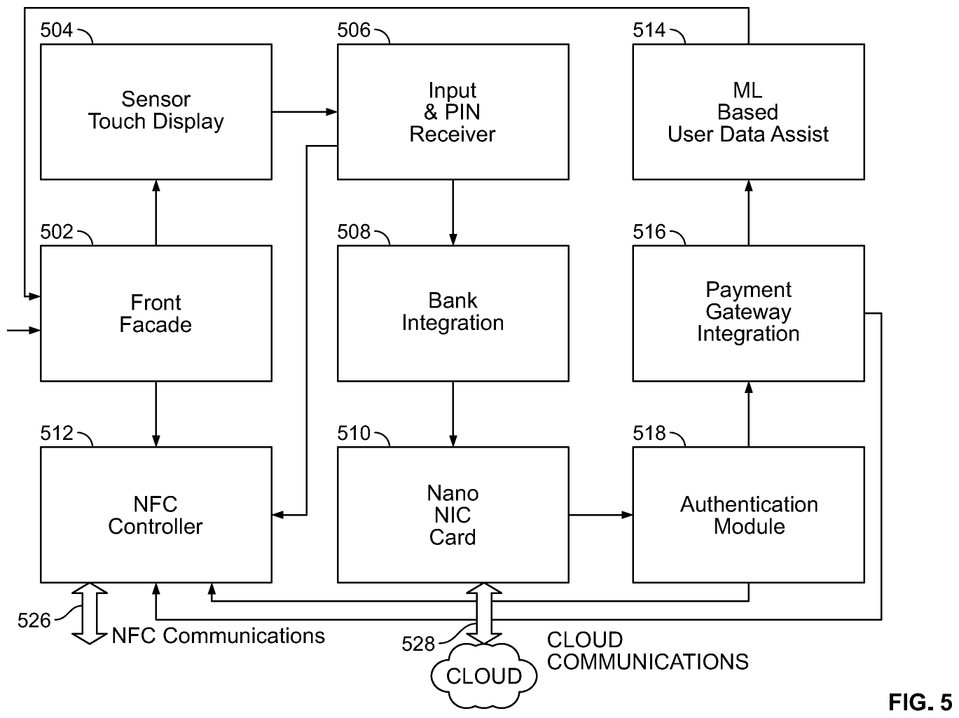

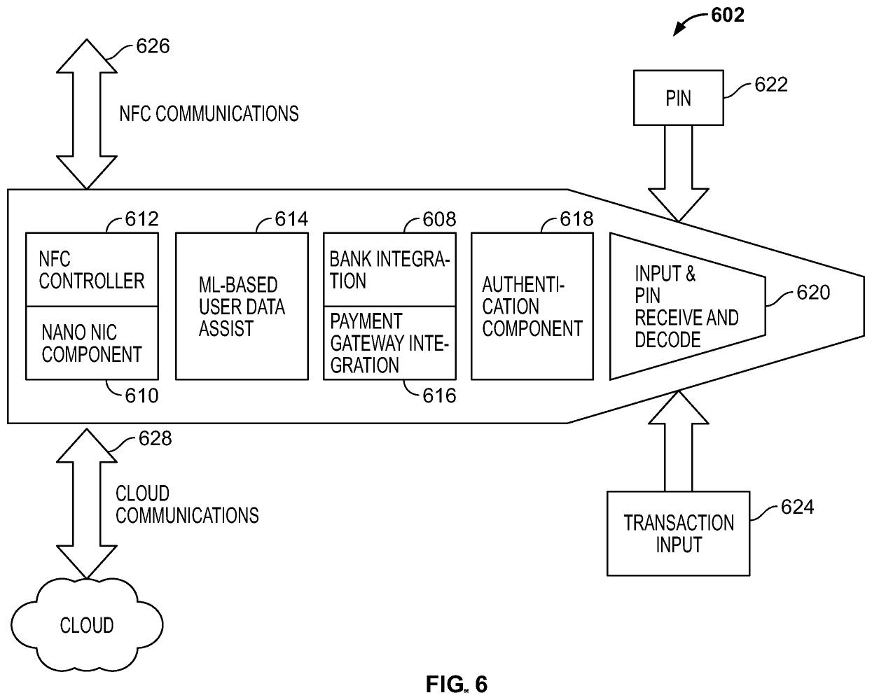

FIG. 3 shows another illustrative apparatus in accordance with the principles of the disclosure. The illustrative apparatus preferably includes card 300 and stylus 306. Each of card 300 and stylus 306 are equipped with, and thereby enabled to communicate using, near-field communication (NFC) hardware (or other suitable short-range communication hardware), as described in more detail below in FIGS. 5 and 6. It should be noted that NFC hardware in card 300 is preferably configured to electronically communicate with NFC hardware in stylus 306. It should be further noted that such communication should preferably be conducted in a device agnostic fashion, as described above. To reiterate, the device-agnostic aspect of the communication may preferably enable, in a first embodiment, a stylus operating a first Operating System (OS) to communicate with a device operating with a second OS.

In addition, card 300 is equipped a screen 302 and text 304. Screen 302 may be a touch sensitive screen. Screen may be configured to process movements of stylus 306 when stylus 306 is on or relatively close to screen 302.

It should be noted that such a system, for use in accordance with the principles of the disclosure, as shown in FIGS. 3-6 may obtain significant advantages for visually-challenged and/or special needs individuals. Specifically, such a system can enable visually-challenged and/or special needs individuals to make certain marks on someone else's payment instrument and transact with the person. Security for such transactions may require the stylus user to input a PIN. Security for such transactions may also require an electronic handshake between the stylus user and the payment instrument owner as well as a biometric handshake between the owner of the stylus and the stylus itself. Such handshakes ensure that only the owner of the stylus can effectively transact using the stylus. Furthermore, the owner of the stylus may need to know the PIN for the account from which the stylus owner wishes to transact. In certain embodiments, each of the stylus and the payment instrument may be in contact with a remote entity and, in certain embodiments, the remote entities may be in contact with one another to finalize the transaction. It should be noted that the electronic handshakes that occur between the stylus and the payment instrument may preferably enable each of the two devices to provide identification information to one another for use in consummating the transaction.

The transaction itself may include the following aspects. The stylus owner may write a PIN on another's payment instrument and complete an amount the stylus owner wishes to transfer—for example—to the card owner. A visually-impaired or otherwise special needs individual may thereby be enabled to transact in a meaningful, and relatively quick, fashion without sacrificing transaction security.

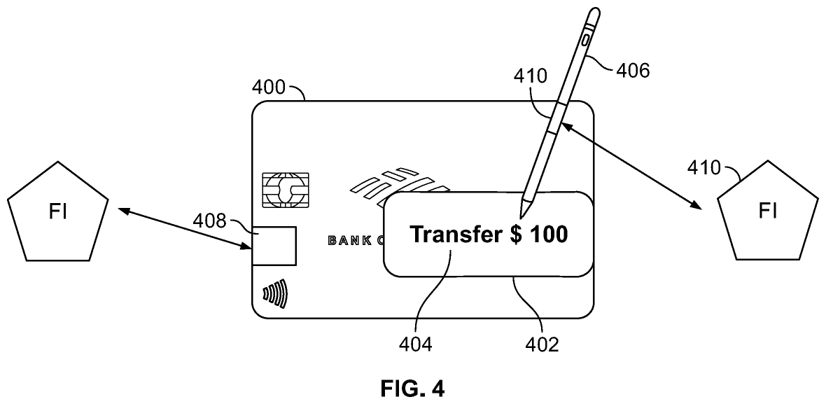

FIG. 4 shows yet another illustrative apparatus in accordance with the principles of the disclosure. More specifically, FIG. 4 shows the card 400, screen 402, text 404 and stylus 406. In addition, FIG. 4 shows a schematic integration with financial institutions such as banks (FIs) 408 and 410. This indicates, schematically, that two wireless electronic communications are ongoing during a transaction according to the principles of the disclosure. One wireless communication informs FI 410 associated with the stylus that the stylus owner has, for example, instructed a payment to be paid to the payment instrument owner. The other wireless communication informs FI 408 that a payment is arriving for the payment instrument owner. In addition, the wireless communication to FI 408 should preferably trigger an alert to be sent to the payment instrument owner regarding the receipt of a payment from the stylus owner.

FIG. 5 shows yet another illustrative apparatus in accordance with the principles of the disclosure. The apparatus in FIG. 5 is a schematic card architecture for use with embodiments set forth herein. The front façade of the card is indicated at 502. Front façade 502 of the card architecture should be understood, in certain embodiments, to include a processor that provides central processing for the card.

A sensor touch display is shown on the card at 504. In order to make front façade 502 more efficient and less resource-consumptive, the card architecture may leverage a Machine-Learning (ML) based user-data-assist, as shown at 514.

Over time, this component may enable the user to process more electronic card functions at a quicker rate. ML-based user-data-assist 514 may preferably continuously, or periodically, monitor and review prior user actions and circumstances, such as, for example, prior user payments, prior receipts and any other suitable user actions, and reactions to user actions. Other examples of prior user actions and circumstances may include a prior user consolidation of a number of actions into a single action or a received payment for a transaction. It should be noted that reverse transactions—i.e., where the payment is being transferred from the payment instrument to the stylus owner's account—are also possible and within the scope of the current disclosure.

In certain embodiments, ML-based user-data-assist 514 may invoke certain pre-determined actions based on a user-determined, or system-defined, protocol. Such actions may be based on digital signatures associated with the pattern of events that the stylus has received and/or reviewed.

One critical aspect of the embodiments set forth herein is that the operating system on the stylus should preferably provide communication protocols that are agnostic to the operating system of the payment instrument with which the stylus is communicating. Furthermore, the operating system on the payment instrument should preferably provide communication protocols that are agnostic to the operating system of the stylus. One example of such communication protocols includes near-field communication (NFC) protocols which may be agnostic to the underlying operating system associated with the stylus and the payment instrument.

Based on the foregoing, it should be understood that a pre-determined stylus—that is natively designed to work with an iPhone by Apple Computing of Cupertino, Ca—should be able to successfully communicate with a non-iPhone based payment instrument, such as, for example, an OS that is designed to work with an Android phone manufactured by Alphabet Inc. of Moutain View, California, independent of any additional software plug-ins or additional hardware components.

Based on the review of prior user actions, responses to same, and/or user keystrokes, gestures, voice commands, etc. —ML component 514 may, based on its review, prompt the user to select one or more future action(s). These future actions may be selected by ML component 514 based on the context of the review actions.

In certain embodiments, ML component 514 may be configured to receive current, relatively current and/or past information from the payment gateway integration (PGI) 516. Such payment can preferably provide training information for establishing the models used by the ML-based component 514. It should be noted that ML component 514 preferably communicates directly with front façade 502 and is guided by the processor located therein. As such, ML component 514 may be situated so as to be located between PGI 516 and front façade 502 such that ML component 514 can act as a pass-through to front façade 502 for payment information generated by PGI 516.

The sensor display at 504 preferably is configured to receive the input and PIN information and is coupled to input and PIN receiver 506. Input and PIN receiver 506 preferably are configured to process relevant and suitable input and PIN 506. It should be noted that in addition to the fact that receiver 506 is configured to receive an input and PIN from sensor touch display 504 receiver is also coupled to bank integration component 508. This enables receiver to integrate with a financial institution (FI) using a nano network interface card (NIC) 510 and wirelessly obtain authentication from the cloud 510. NIC 510 preferably obtains authentication by working in combination with authentication module 518. Once authentication has been processed, PGI may instruct near-field communication (NFC) controller 512, in combination with processor in front façade 502, to execute (in response to a signal from the stylus conducted via NFC controller 512) a transfer using NFC communications 526.

The premise of one embodiment of the communication protocols according to the disclosure is as follows: the stylus owner writes to the card the amount of a transfer to the card user—and then the stylus owner also inputs a PIN associated with the account which is associated with the stylus. In addition, the stylus communicating, in an electronic handshake via NFC with the card owner, to retrieve the account information from the card. Also, the card receives, via the handshake using NFC, the stylus account information. In addition, the stylus receives the card information as well as the information written to the card. Then the stylus can transmit the information to its FI and authorize the transfer information.

Alternatively, the stylus can leverage the communication capabilities to send a message to the stylus FI authorizing the transaction. Such an embodiment preferably reduces the need for communication hardware on the stylus because the stylus is equipped with only sufficient hardware to communicate with the card—e.g., NFC hardware—and doesn't require a nano network integration card (NIC) card or other similar and/or suitable communication hardware. In certain embodiments, the stylus can obtain the information from detecting the user movement of the stylus. In yet another embodiment, the transaction may invoke two remote entities—one associated with the payment instrument and one associated with the stylus.

FIG. 6 shows still an illustrative apparatus of a stylus in accordance with the principles of the disclosure. FIG. 6 shows numerous components that may be used in a stylus 602 according to the disclosure. One or more of the components may be used in a stylus according to the current disclosure.

At 620, stylus preferably includes a PIN 622 and input 624 receive and decode component. PIN may include any suitable set of input alpha-numeric characters for personal identification. Input 624 may include any contacts, motions, gestures, or other movements associated with stylus 602. Input 602 may receive such contacts, motions, gestures, or other movements and convert same into signals that correspond to the digital information contained within such PIN and/or input.

At 608, a bank integration component may be shown separately from, or in combination with, a payment gateway integration component. Components 608 and 610 indicate, schematically, that these two components 608 and 610 are capable of providing communications components for supporting two or more separate electronic communications channels.

Such communications channels may form part of a transaction according to the principles of the disclosure. One wireless communication using one or more of bank integration 608 and payment gateway integration (PGI) 610 can be used to inform an FI associated with the stylus that the stylus owner has, for example, instructed a payment to the payment instrument owner. The other wireless communication, possibly using only PGI 610, can be used to inform the payment instrument (see FIG. 4), that a payment is arriving for the payment instrument owner. Such a communication may trigger a display of an alert on the payment instrument that such a payment is in progress. In addition, the wireless communication to the payment instrument should preferably trigger an alert to be sent to the payment instrument owner regarding the receipt of a payment from the stylus owner.

Stylus 602 may also include authentication component 618. Such an authentication component 618 may be used to support authentication of PIN 622 and input 624. In addition, authentication component 618 may be used to support communications with FIs that use bank integration component 608 and/or payment gateway integration 610 to the extent that such communications rely on handshakes and/or other suitable security issues associated with secure electronic communications.

Stylus 602 may also include machine learning (ML)-based user data assist 614. ML-based user data assist 614 may enable the user to process more stylus functions at a quicker rate. ML-based user-data-assist 514 may preferably continuously, or periodically, monitor and review prior user actions, movements, contacts, gestures and/or circumstances and any other suitable user actions, and reactions to user actions. Such review may be used to provide and/or trigger signals that correspond to the desired user outcome. Such triggers may be based on algorithms that determine probable user actions in view of the review of the actions, etc.

Additional components that may be included in stylus 602 are Nano Network Interface Card (NIC) component 610 and/or Near Field Communication (NFC) controller 612. NFC controller 612 may be used for controlling communication using near field communications. These near field communications 626 may include communications with a payment instrument such as the payment instrument shown in FIG. 4. Nano NIC component 610 may be used to support cloud communications 628 with a target located in the cloud or in some other internet-accessible location.

Thus, systems and methods for scribble text payment technology are provided. Persons skilled in the art will appreciate that the present invention can be practiced by other than the described embodiments, which are presented for purposes of illustration rather than of limitation. The present invention is limited only by the claims that follow.

What is claimed is:

1. A stylus for use in communicating with a payment instrument, the payment instrument comprising a front façade, a sensor touch display, an input and PIN receiver, a financial institution integration component, a payment gateway integration component, a near field communication (NFC) controller, and an authentication module, the stylus comprising:
an input receive and decode component for receiving input related to authentication of a stylus user and for receiving input related to a transaction with the payment instrument;
an integration component for supporting communication with a remote entity and authorizing transactions occurring at the remote entity;
a stylus NFC controller for wirelessly communicating, using NFC protocol, with the payment instrument via the NFC controller associated with payment instrument; and
a network interface card component for communicating wirelessly with the remote entity.

2. The stylus of claim 1 further comprising a nano-network integration card component (NIC) for communicated wirelessly with the remote entity.

3. The stylus of claim 1 further comprising a machine-learning based user data assist component that receives and reviews the communication with the remote entity and, based upon the receipt and the review, is configured to invoke one or more of a plurality of action in response to a pre-determined protocol.

4. The stylus of claim 1, further comprising an authentication component for working in tandem with the input receive and decode component to authenticate the stylus user and the input related to the transaction.

5. The stylus of claim 1, further configured to electronically confirm, using the NFC controller, a term of a transaction as marked by the stylus on the sensor touch display of the payment instrument.

6. The stylus of claim 1, further configured to record, using the input receive and decode component, movements of the stylus in the air and to transmit, using the NFC controller, said movements from the stylus to the payment instrument.

7. A combination stylus and payment instrument, the combination comprising:
a payment instrument comprising:
a front façade;
a sensor touch display;
an input and PIN receiver;
a financial institution (FI) integration component;
a payment gateway integration component;
a near field communication (NFC) controller, and an authentication module
a stylus comprising:
an input receive and decode component for receiving input related to authentication of a stylus user and for receiving input related to authenticating a transaction, said transaction performed using the payment instrument;
an integration component for supporting communication with a remote entity and authorizing transactions occurring, at least in part, the remote entity;
a stylus NFC controller for wirelessly communicating, using a device-agnostic NFC protocol, with the payment instrument via the NFC controller associated with payment instrument; and
a network interface card component for communicating wirelessly with the remote entity.

8. The combination of claim 7, wherein the nano-network integration card component (NIC) is configured for communicating wirelessly with the remote entity, said communicating wirelessly with the remote entity is performed on a frequency other than an NFC communications frequency.

9. The combination of claim 7, the payment instrument further comprising a machine-learning based user data assist component that receives and reviews the communication with the remote entity and, based upon the receipt and the review of communications with the remote entity, is configured to invoke one or more of a plurality of actions in response to a pre-determined protocol.

10. The combination of claim 7, the stylus further comprising an authentication component for working in tandem with the input receive and decode component to authenticate the stylus user and the input related to the transaction.

11. The combination of claim 7, the payment instrument further configured to electronically confirm, using the NFC controller, at least one term of the transaction as marked by the stylus on the sensor touch display of the payment instrument.

12. The combination of claim 7, further configured to record, using the input receive and decode component, movements of the stylus in the air and to transmit, using the NFC controller, said movements from the stylus to the payment instrument.

13. A method for using a combination stylus and payment instrument, the stylus comprising an input receive and decode component for receiving input related to authentication of a stylus user and for receiving input related to authenticating a transaction, said transaction performed using the payment instrument, and a stylus NFC controller for wirelessly communicating, using a device-agnostic NFC protocol, with the payment instrument via a near field communication (NFC) controller associated with the payment instrument and the payment instrument further comprising a front façade, a sensor touch display, an input and PIN receiver, a financial institution (FI) integration component, a payment gateway integration component, a network interface card (NIC) component for communicating wirelessly with a remote entity, and an authentication module, the method comprising:
receiving the information for the transaction at the payment instrument, said receiving comprising receiving touch signals on the sensor touch display, said touch signals being administered by the stylus;
using the NFC controller associated with the payment instrument to confirm to the stylus the receiving the information for the transaction;
using the NIC component to transmit to the remote entity the information for the transaction; and
using the NIC component to receive from the remote entity confirmation of the transaction.

14. The method of claim 13, receiving and reviewing, using the machine-learning based user data assist component, the transmission to, and confirmation from, the remote entity and, based upon the receipt and the review of transmission to, and confirmation from, the remote entity, invoking one or more of a plurality of actions vis-à-vis the transaction in response to a pre-determined protocol.

15. The method of claim 13, authenticating, using the authentication component, said authentication component working in tandem with the input receive and decode component, to the stylus the input related to the transaction.

16. The method of claim 13, electronically confirming, using the NFC controller of the stylus, at least one term of a transaction as marked by the stylus on the sensor touch display of the payment instrument.

17. The method of claim 13, further configured to record, using the input receive and decode component, movements of the stylus in the air and to transmit, using the NFC controller, said movements from the stylus to the payment instrument.
